(19) United States
(12) Patent Application Publication
(10) Pub. No.: US 2010/0023341 A1
(43) Pub. Date: Jan. 28, 2010

(54) METHOD FOR RULE-BASED GIFT GIVING

(75) Inventors: Patrick LEDBETTER, Arlington, VA (US); Adam LUDWIG, New York, NY (US)

Correspondence Address: LAHIVE & COCKFIELD, LLP;FLOOR 30, SUITE 3000, ONE POST OFFICE SQUARE, BOSTON, MA, 02109, US

(73) Assignee: REEL DRINKS LLC, Arlington, VA (US)

(21) Appl. No.: 12/475,122

(22) Filed: May 29, 2009

Related U.S. Application Data
(60) Provisional application No. 61/057,106, filed on May 29, 2008.

(51) Int. Cl. G06Q 99/00

(52) U.S. Cl. 705/1

(57) ABSTRACT

A method for rule-based gift giving method collects information about life events of one or more friends from one or more social network systems and/or from one or more online profiles. The gathered information may be organized in a news stream format or a calendar items format. The user creates rules including parameters such as monetary value of the gift, identity of the recipient and the life event on which to send the gift. The user may generate a default list of friends who will automatically receive user-selected gifts on user-selected life events. According to another embodiment, the user may generate an on-demand list of friends who will receive gifts on selected life events upon user's approval.

### RELATED APPLICATION

The present application claims the benefit of U.S. Provisional Patent Application No. 61/057,106 entitled “A Method for Rule-Based Gift Giving”, filed on May 29, 2008, the content of which is incorporated by reference in its entirety.

### BACKGROUND INFORMATION

Social networks enable users to create lists of friends. First a user creates a profile with a social network, including personal information such as birthday, education status, marital and/or relationship status, current employer, current location, etc. The social network systems often provide news feeds to users about changes in personal information of friends of the user. For example, if a first user has a second user listed as a friend, the first user is notified when the second user gets engaged, changes his/her job, has his/her birthday, etc. An example of news feed feature is provided by Facebook where the life events of friends on a user's profile is provided on the user's home page when the user signs in to his/her Facebook account.

However, the current social networks do not provide means for users to send gifts to their friends. Furthermore, the current social networks do not provide a means for automating the gifting process through gift scheduling or rules-based gifting. Upon being notified of a change in a friend's personal information, the user has to navigate various sources, such as websites, to find, buy and send gifts to the friends. The present invention enables a user to create rules for sending gifts to friends on user-specified life events.

### SUMMARY

The present invention enables a user to collect information about life events of one or more friends from one or more social network systems and/or from one or more online accounts, profiles, etc. The list of life events may be stored on the user's profile on one or more of the social network systems. Alternatively, the list of life events may be sent by one or more social network systems to a database or website, such as a rule-based gift giving website.

Once the life events information is collected, the information may be organized in a user-preferred format such as a list, news streams and/or calendar items. The user may generate one or more rules identifying one or more friends to whom to send gifts on selected life events. According to one embodiment, the user may generate a default list of friends who will automatically receive user-selected gifts on user-selected life events. According to another embodiment, the user may generate an on-demand list of friends who will receive gifts on selected life events upon user's approval.

### BRIEF DESCRIPTION OF FIGURES

These and other aspects of this invention will be readily apparent from the detailed description below and the appended drawings, which are meant to illustrate and not to limit the invention, and in which:

FIG. 1 is a flowchart illustrating generating and using a rule-based gift giving method;

FIGS. 2A-2B are flowcharts illustrating an automated rule-based gift giving method;

FIGS. 2A and 2C are flowcharts illustrating a non-automated rule-based gift giving method;

FIG. 3 illustrates an exemplary user interface for the rule-based gift giving website;

FIG. 4A illustrates a first exemplary rule created using the rule-based gift giving system; and

FIG. 4B illustrates a second exemplary rule created using the rule-based gift giving system.

### DETAILED DESCRIPTION

The terms “giftor” or “user” are used throughout the description to indicate the party using the rule-based gifting system to give a gift to another party.

The terms “giftee” or “recipient” are used throughout the description to indicate the party receiving the gift from the giftor or user.

The term “friend” is used throughout the description to indicate a person listed in a social network of another person, without taking into consideration a personal intimacy level.

The invention can be used with different types of gifts, such as living, perishable or inanimate gifts, including but not limited to cash, food, drink, clothing, accessories, household items, flowers, travel arrangements, entertainment tickets, etc.

The present invention enables a giftor to collect information about life events of one or more friends. The life events include, but are not limited to, scheduled events such as birthdays, national and/or religious holidays, graduations, and unscheduled events such as relationship status changes (e.g., engagement or marriage), job changes, moves from one location to another, etc. The life events may be gathered from one or more social network systems, such as MySpace, Facebook, etc. and/or from one or more online accounts, profiles, etc. The list of life events may be stored on the user's profile on one or more of the social network systems. Alternatively, the list of life events may be sent by one or more social network systems to a database or another website, such as a rule-based gift giving website.

Once the life events information is collected, the information may be organized in a user-preferred format such as a list, news streams and/or calendar items. The news stream or the list may also include information about gifts received by the user. The user may generate a sub-list of friends to whom to send gifts on selected life events. According to one embodiment, the user may generate a default list of friends who will automatically receive user-selected gifts on user-selected life events. According to another embodiment, the user may generate an on-demand list of friends who will receive gifts on selected life events upon user's approval. According to various embodiments of the present invention, a gift may be a real-life gift or a virtual gift.

According to various embodiments of the present invention, the user may create a profile with a rule-based gift giving website. The user's financial information may be stored with the rule-based gift giving website. Alternatively, the rule-based gift giving website may access another website or a database where the user's financial information may be stored. The rule-based gift giving website may interact with financial institution websites, such as escrow service websites, bank or credit card websites, various online shopping websites and social networking websites. The social networking websites may provide a hyperlink to the rule-based gift giving website, for example in proximity of the life event information presented to the user. In other words, the user may be prompted with a hyperlink to the rule-based gift giving website when there is a life event notification for a friend on the user's social networking system profile. One of ordinary skill in the art would appreciate that the use of hyperlinks are for illustrative purposes and that the user may be prompted using other means, including but not limited to pop-up messages, emails, short messages sent to wireless devices, etc.

For example, the user may have a first group of friends, a second group of friends and a third group of friends gathered from one or more social networking systems, or online portals. Each group of friends may include one or more friends. The user may create a first rule that automatically sends flowers to the first group of friends on their birthdays. When a birthday of a friend in the first group of friends arrives, the social networking system may prompt the rule-based gift giving system. Alternatively, the rule-based gift giving system may acquire and store the personal information of each friend on the user's lists. The rule-based gift giving system may update this information when the information changes on the one or more social network systems. For example, the rule-based gift giving system may use a flower delivery website to select and send a pre-defined kind of flowers or flowers worth a pre-defined amount of money. The rule-based gift giving system may use the user's financial information stored on the rule-based gift giving website or access and use the user's financial information stored elsewhere.

The user may further create a second rule that informs the user when a friend from the second group of friends gets engaged. Upon receiving the notification, the user may authorize to send a gift to the friend in the second group of friends or may simply ignore the notification. The user may also create a rule to automatically send a gift from a list of user-selected gifts to a friend in the third group of friends on a selected life event, such as Christmas. The first, second and third groups of friends may be, but are not required to, mutually exclusive.

According to various embodiments of the present invention, the user may also send a personal note, such as an electronic greeting card, an email or a short message (SMS) along with the gift. The personal note may be sent directly to giftee' profile on the social networking system, to an email address or a cellular phone registered with the social networking system or the rule-based gift giving system.

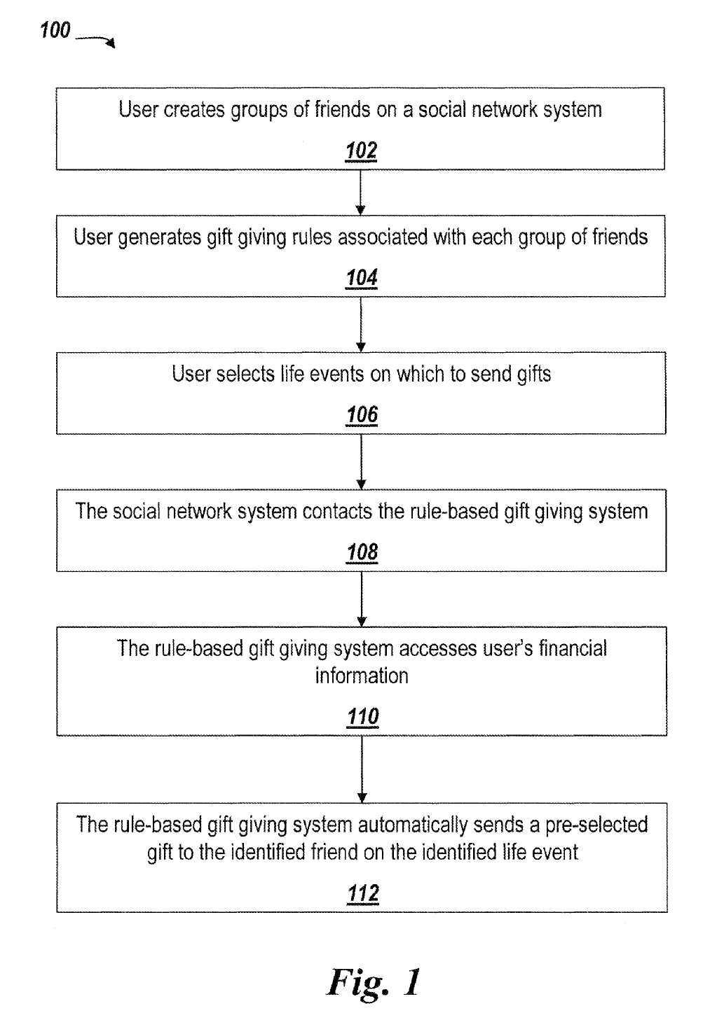

FIG. 1 is a flowchart illustrating generating and using a rule-based gift giving method 100. As illustrated in FIG. 1, the user first creates groups of friends on a social network system (step 102). Each group of friends may include one or more friends. The user may also create groups of friends from one or more social network systems, email portals, blog groups, etc. The user then generates gift giving rules associated with each group of friends (step 104). The rules may include setting type of gifts, amount of money to be spent on a gift, specifications of the gift, such as type, color, size, friend-preferred brands, etc. The rules may also include selecting one or more life events on which to send gifts (step 106). The rules may be stored on a rule-based gift giving system, including but not limited to a website or a database. According to an embodiment the gift giving website may be embedded in the social network system. When the life event occurs, the social network system may contact the rule-based gift giving system (step 108). Alternatively, the rule-based gift giving system may contact the social network system to receive updates about a user's friends life events. The rule-based gift giving system may access the user's financial information (step 110). The user's financial information may be stored on the rule-based gift giving system. Alternatively, the user may instruct the rule-based gift giving system to access the user's financial information stored on a financial institution website or a database. The rule-based gift giving system may automatically send a pre-selected gift to the identified friend on the identified life event (step 112).

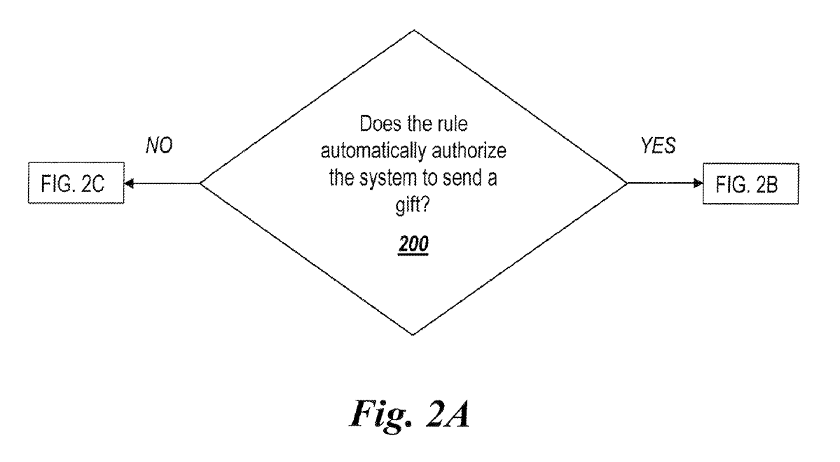

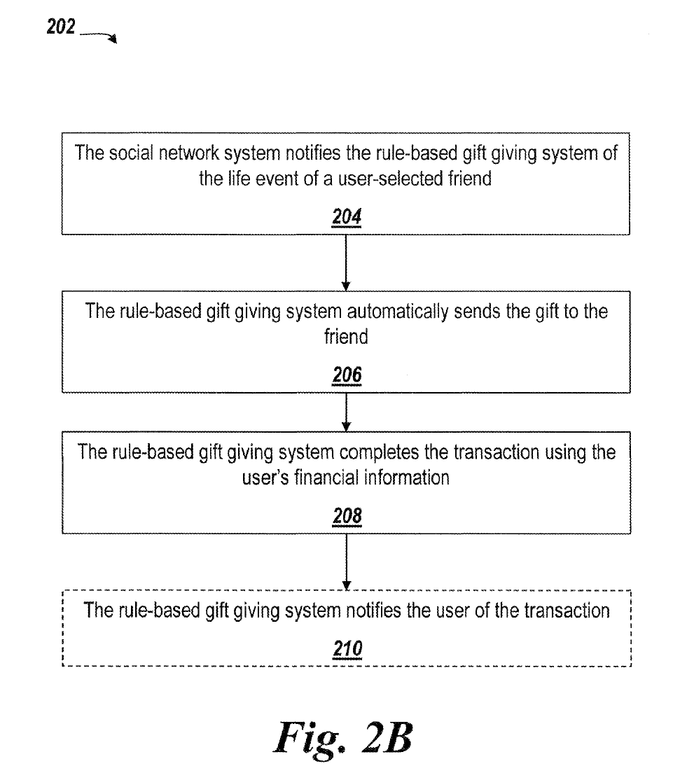

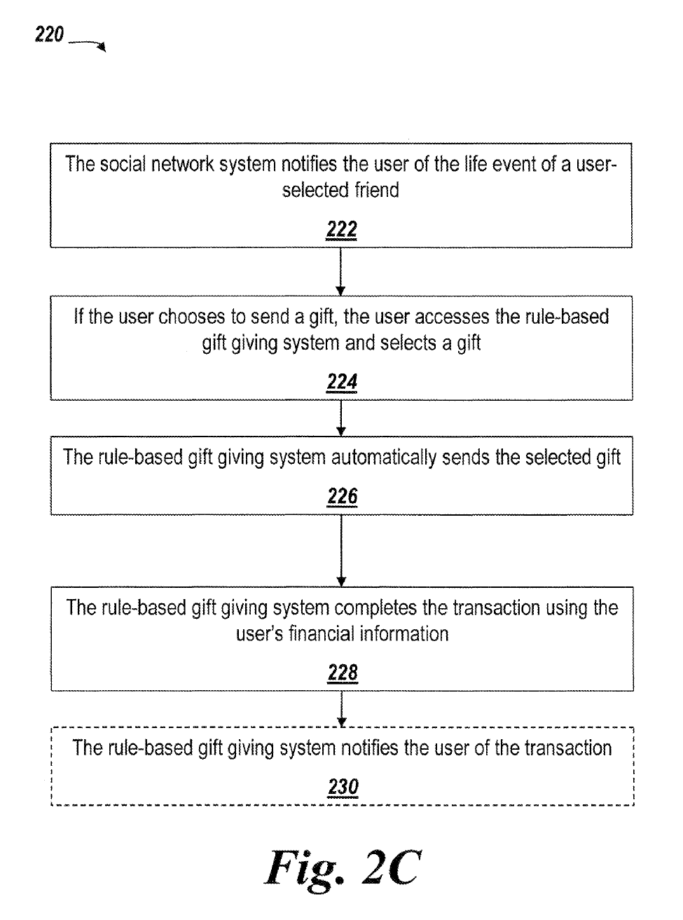

According to various embodiments of the present invention, the rule-based gift giving may automatically send gifts to selected friends on selected life events. Alternatively, the user may request to be prompted with a message for a selected type of life events for one or more friends. The user may then choose to send a gift using the rule-based gift giving, or the user may simply ignore the prompt. FIG. 2A illustrates the first step of a flowchart asking whether the rule created by the user automatically authorizes the system to send a gift (step 200). If the rule is an automated gift giving rule, the flowchart proceeds to the flowchart 202 illustrated in FIG. 2B.

As illustrated in FIG. 2B, according to an automated gift giving rule, the social network system may directly notify the rule-based gift giving system when the user selected life event occurs for a user-selected friend (step 204). The rule-based gift giving system may automatically send the user-selected gift to the giftee (step 206). The rule-based gift giving system may either access a website selling the user-selected gift or may transfer funds as a gift to the friend's financial account to be used toward the user-selected gift. For example, if the user selected sending flowers as a gift, the rule-based gift giving system may access a florist website and select the user-identified flowers. The user may identify a type of flowers, such as roses, or the user may identify an amount that may be spent on the transactions, such as $50. The user may further identify which website to use in the rule. Alternatively, the user may direct the rule-based system to use a random website for the selected gift, such as a random florist website on the internet. Similarly, when the user selected sending flowers as a gift, if the giftee has a financial account registered with the rule-based gift giving system, the rule-based gift giving system may transfer user-specified funds to the giftee' registered financial account to be used for buying flowers. In the automatic rule-based gift giving method, the rule-based gift giving system completes the transaction using the user's financial information (step 208). Optionally, the rule-based gift giving system may notify the user when the transaction is complete (step 210).

If the rule is a non-automated gift giving rule, the flowchart proceeds to the flowchart 220 illustrated in FIG. 2C. As illustrated in FIG. 2C, according to a non-automated gift giving rule, the social network system or the rule-based gift giving system may notify the user when the life event occurs for a user-selected friend (step 222). If the user chooses to send a gift, the user may access the rule-based gift giving system and selects a gift by creating a rule (step 224). The social network system may provide a hyperlink to the rule-based gift giving system's website. The hyperlink may be provided in proximity of the notification of the life event. One of ordinary skill in the art would appreciate that the use of hyperlinks are for illustrative purposes and should not be construed as limiting. Pop-up screens, audio/visual alerts, hotspots are among examples of ways to provide access to the rule-based gift giving website. Alternatively, the life event updates may directly appear on the rule-based gift giving system's website. The rule-based gift giving system may automatically send the user-selected gift to the giftee (step 226). As indicated above, the rule-based gift giving system may either access a website selling the user-selected gift or may transfer funds as a gift to the friend's financial account to be used toward the user-selected gift. The rule-based gift giving system may complete the transaction using the user's financial information (step 228). Since the user elects to send the gift in the non-automated rule-based system, it is not necessary to notify the user when the transaction is complete. However, according to various embodiments of the present invention, the rule-based gift giving system may still notify the user of the transaction for improved user profile security purposes (step 230).

According to various embodiments of the present invention, the user may be prompted with an option to send a gift to a friend on friend's life events. If the user wishes to send a gift, the user may proceed to the gift giving website and send the gift without creating a rule. For example, on a birthday of a friend, the user may be prompted with a question whether the user wishes to send a gift to the friend. The user may choose to send the gift and proceed with the steps provided by the gift giving system without creating a rule.

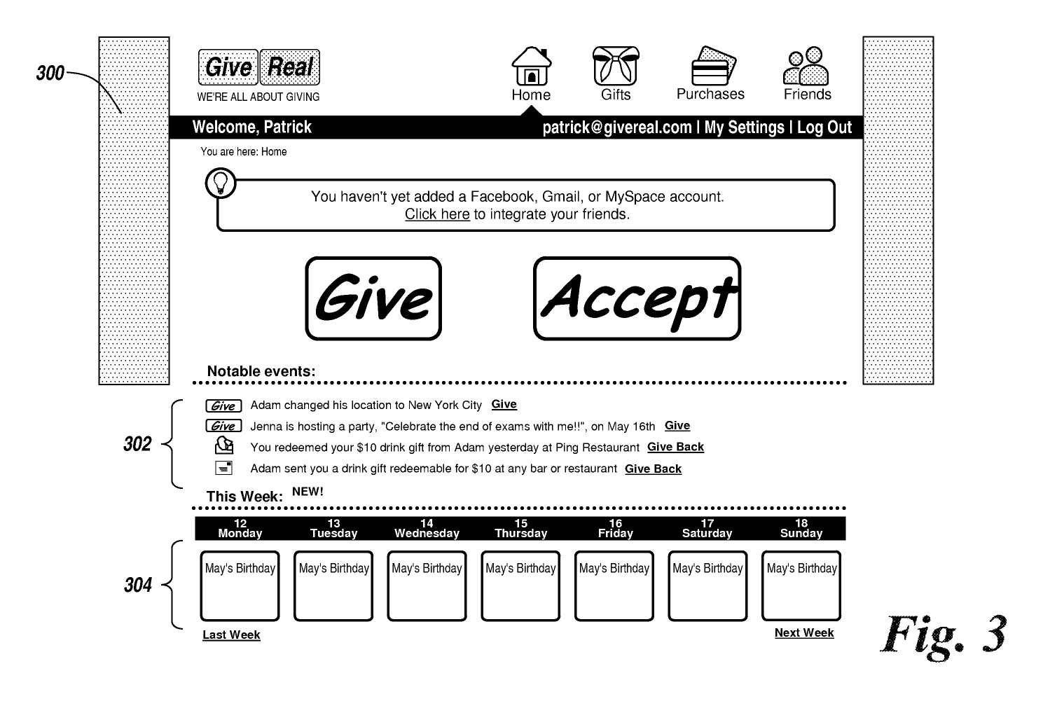

FIG. 3 illustrates an exemplary user interface 300 of the rule-based gift giving website. As illustrated in FIG. 3, the rule-based gift giving website may include a news feed 302 comprising life event changes of a user's friends. The news feed 302 may also display information about the gifts received by the user. The news feed 302 may provide the option to send a gift, for example in form of a hyperlink, next to each life event update. According to various embodiments of the present invention, the rule-based gift giving website may also display the life event updates in form of a calendar 304. The calendar view 304 may be customized to be displayed in daily, weekly or monthly formats. One of ordinary skill in the art would appreciate that the news feed view 302 and the calendar view 304 are exemplary forms to illustrate life event updates and that alternative forms such as email messages, short messages (SMS) sent to wireless devices, pop-up reminder messages may be used for similar purpose.

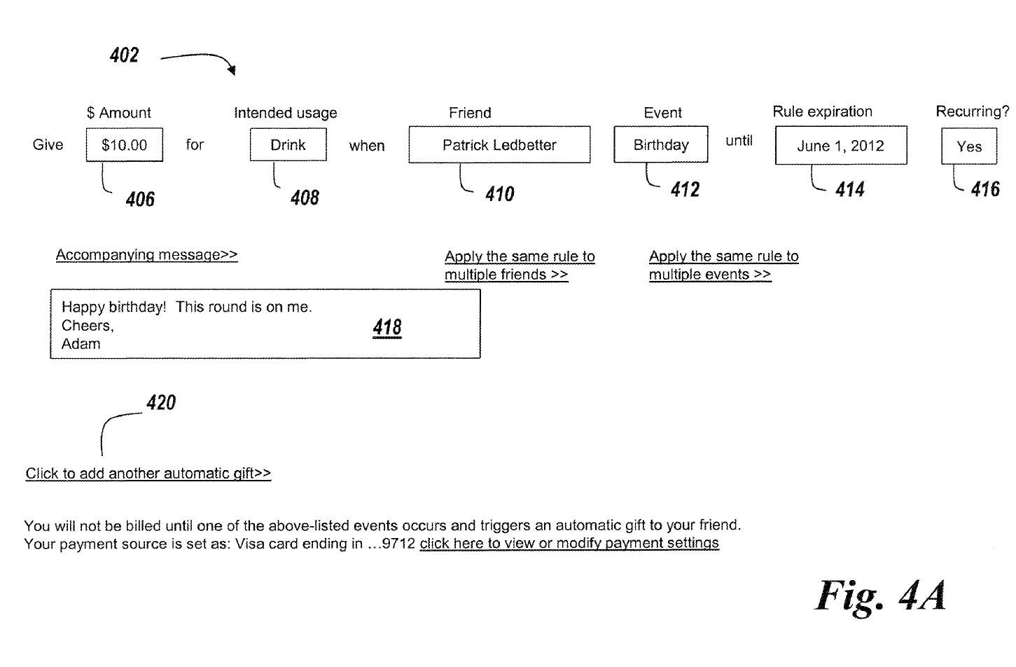

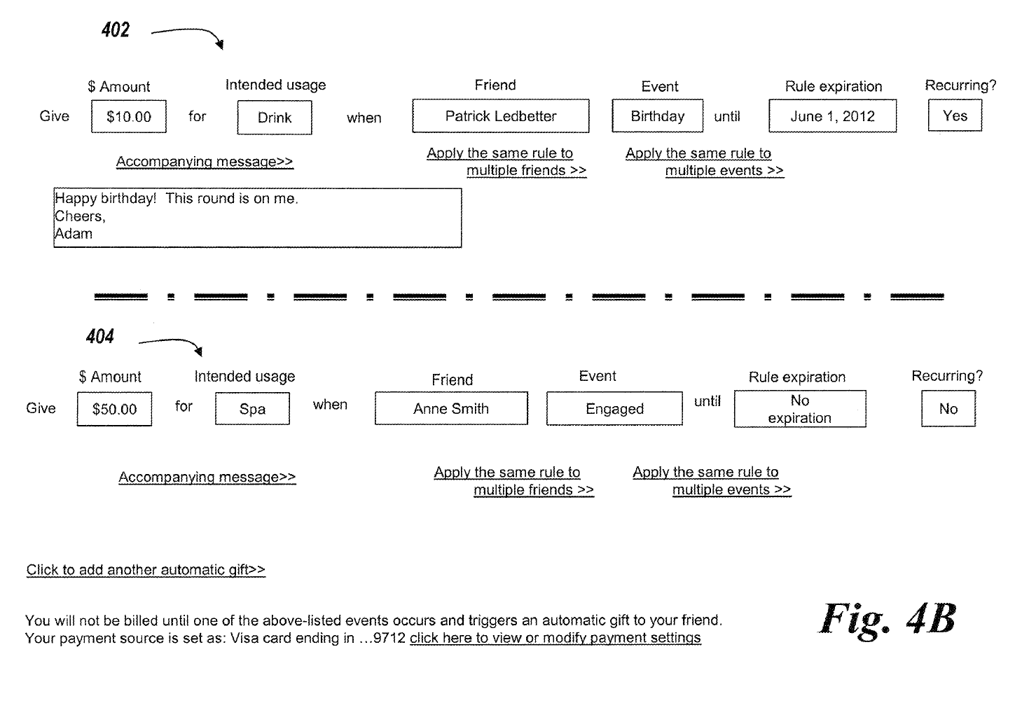

FIG. 4A illustrates a first exemplary rule 402 created by a user using the rule-based gift giving system. According to the first exemplary rule 402, the user indicates the amount of money 406 to be spent on the gift. The user further indicates the intended use of the gift 408. the intended use 408 may also identify the type, color, size, brand, quantity of the gift. The rule may also include an indication of the recipient 410. The recipient 410 may be a single person as illustrated in FIG. 4A. Alternatively, the recipient may be a group of friends. The rule may further include the type of life event 412 on which the rule-based gift giving system will be sending the gift to the identified recipient 410. According to various embodiments of the present invention, the rule may include an expiration date 414 and the option of being a recurring gift 416. According to the first exemplary rule 402 illustrated in FIG. 4A, the recipient will receive a $10 worth of drinks every year on his birthdays until Jun. 1, 2012. The rule-based gift giving system may also provide the user with an option of sending a personal message 418 to the recipient. The user may identify himself/herself on the message or may choose to stay anonymous. The rule-based gift giving system may allow the user to add additional rules by selecting the option 420.

FIG. 4B illustrates a second exemplary rule 404 created using the rule-based gift giving system. According to the second exemplary rule 404 illustrated in FIG. 4B, the recipient will receive a $50 worth of a spa visit as her engagement present. The gift is a one time gift only and there is no expiration date for this gift.

While the invention has been shown and described with reference to specific preferred embodiments, it should be understood by those skilled in the art that various changes in form and detail may be made therein without departing from the spirit and scope of the invention.

What is claimed is:

1. A method for giving one or more gifts according to one or more user generated rules, the method comprising:
generating a list of one or more individuals;
gathering information about life events of the one or more individuals;
creating one or more rules specifying a plurality of parameters, the plurality of parameters comprising one or more of individuals, life events and gifts; and
sending gifts to the individuals specified in the one or more rules according to the plurality of parameters of the one or more rules.

2. The method of claim 1, wherein the life events comprise one or more of birthday, change of marital status, change of employer, change of location, religious holidays, national holidays and graduation.

3. The method of claim 1, wherein the list of one or more individuals is gathered from one or more online profiles on social network systems or messaging portals.

4. The method of claim 1, wherein the plurality of parameters further comprise a monetary value of the gift.

5. The method of claim 1, wherein the plurality of parameters further comprise one or more attributes of the one or more gifts, the one or more attributes comprising color, dimension, brand, type, size or quantity.
